(19) United States
(12) Patent Application Publication
(10) Pub. No.: US 2010/0316123 A1
(43) Pub. Date: Dec. 16, 2010

(54) MOVING IMAGE CODING DEVICE, IMAGING DEVICE AND MOVING IMAGE CODING METHOD

(75) Inventor: Kazuyuki INOKUMA, Kyoto (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/862,431

(22) Filed: Aug. 24, 2010

Related U.S. Application Data
(63) Continuation of application No. PCT/JP2009/001813, filed on Apr. 21, 2009.

(30) Foreign Application Priority Data
Apr. 24, 2008 (JP) 2008-113820

(51) Int. Cl. H04N 7/32

(52) U.S. Cl. 375/240.12; 375/E07.243

(57) ABSTRACT

A moving image coding device for performing inter-frame prediction coding can prevent memory traffic for reference images from increasing due to increase of an image size. The moving image coding device comprises a multiple frame parallel processing inter-frame prediction coding unit 101 for generating a necessary reference image whenever needed in synchronization with coding, and a coding-linked perfect decoding reference image generating unit for coding plural frames in parallel. The moving image coding device thus technically characterized makes it unnecessary to store reference images as an image to be stored in a memory, thereby enabling large reductions in memory capacity and memory traffic. Further, the moving image coding device capable of decoding plural frames in parallel at a time can reduce a decoding volume of the coding-linked perfect decoding reference image generating unit and the memory traffic/.

### FIELD OF THE INVENTION

The present invention relates to a moving image coding device used to compress and code a moving image, and an imaging apparatus provided with the moving image coding device, and a moving image coding method.

### BACKGROUND OF THE INVENTION

Along with the widespread of video movie among consumers in recent years, digital still cameras and mobile telephones with camera penetrated into the market. Using these advancing technologies, consumers are now able to readily handle images on their own. The increasingly growing compression technique facilitated the handling of moving images which have more data volume than still images. Under the ongoing trend, moving images, as well as the video movie cameras, can be processed by the digital still cameras and camera mobile telephones. To compress the moving image, inter-frame prediction coding which utilizes correlation between frames is conventionally used to increase a compression ratio. When the inter-frame prediction coding is employed, it is necessary to store images for reference for at least one frame (hereinafter, referred to as reference image). Further, motion compensation is necessary to improve the effect of the inter-frame prediction coding, wherein the motion of images is detected to accordingly detect and code the most correlative parts of the images. This, however, leads to more accesses to the reference images, and such busy accesses to the reference images is emerging as a huge problem in small transportable devices, for example, digital still cameras and camera mobile telephones.

FIG. 9 is a block diagram of a structure of a digital still camera illustrated as an example of an imaging apparatus provided with a moving image coding device.

In the illustration of FIG. 9, 801 denotes an image sensor such as CCD, 802 denotes a TG (Timing Generator) which drives the image sensor 801, 803 denotes an AFE (Analog Front End) which analog-processes signals outputted from the image sensor 801, 804 denotes an AD converter which converts analog signals into digital signals, and 805 denotes a camera image processor. The camera image processor 805 has a camera signal processing unit 806, a moving image coding unit 807a, a display unit 808, a memory card control unit 809, a memory controller 810, and a CPU 811. A reference symbol 812 denotes a memory such as SDRAM, and 813 denotes a memory card. A single semiconductor chip (LSI) conventionally constitutes the camera image processor 805.

The signal outputted from the image sensor 801 is transmitted to the AFE 803 and then AD converter 804 to be converted into the digital signal therein. The digital signal is then converted into a luminance signal and a color signal by the camera signal processing unit 806 of the camera image processor 805, and then coded by a moving image coding section 807a so that its data volume is compressed. The code data is stored in an external memory card 803 through the memory card control unit 809, and an image is display on the display unit 808. The camera signal processing unit 806, moving image coding section 807a, and display unit 808 store any needed data in the memory 812 via the memory controller 810 to process the data. The CPU 811 controls all of these processing steps.

FIG. 10 is a block diagram of a structure of a conventional moving image coding device used as the moving image coding section 807a of the digital still camera.

In FIG. 10, an input image from the camera signal processing unit 806 is stored in an input image buffer region 901 of the memory 812 via the memory controller 810. The moving image is conventionally coded by each of rectangular small regions called macro blocks, and the input image is stored until all of the data necessary for coding is obtained. The inter-frame prediction coding may reference any future frames for prediction. In that case, the order of coding inputted images does not agree with the chronological order of inputted frames, and more than one frame has to be retained in the memory.

Then, an inter-frame prediction coding section 902 compresses the data volume by taking a differential between the input image and the reference image time-correlated to each other. In doing so, a compression ratio can be increased by detecting the most correlative parts of the images depending on their motions, which is called motion compensation. A predetermined area of the reference images stored in the memory 812 is inputted to a reference image buffer 903. Then, a motion vector searching section 904 searches a motion vector using the images stored in the reference image buffer 903 and inputted image. To search the motion vector, a known conventional method, block matching, for example, is used. When the motion vector is determined by the motion vector searching section 904, a prediction image is generated based on the motion vector by a prediction image generating section 905. The prediction image is a part of the reference image cut out therefrom in the case where the motion vector has an integer-level accuracy, while an image interpolated by a given filtering process is generated in the case where the motion vector has a decimal-level accuracy. Then, a differential image generating section 906 generates an image representing the differential between the prediction image and inputted image.

The differential image is intra-frame coded by an intra-frame coding section 907. As an initial step of the intra-frame coding, image data is converted into frequency components by a DCT (Discrete Cosine Transform) section 908 because the image data converted into frequency components can be more easily compressed. Generally, a human is hardly able to see any changes of high frequency components in an image in contrast to an original image. Therefore, the image data is converted into the frequency components and quantized by a quantizing section 909 to reduce its data volume, and then finally variable-length coded by a variable-length coding section 910. The variable-length coding is a coding method wherein a short code is assigned to data frequently generated to reduce a coding volume. The coding method conventionally employs Huffman coding or arithmetic coding.

Then, a reference image generating section 911 generates reference images used for prediction coding of a subsequent frame and frames thereafter inputted. The reference image is also used by a decoder in a decoding process. Therefore, the reference image is usually generated by decoding code data. In the case of the variable-length coding, which is lossless coding, the reference image is generated by decoding the quantized code data. More specifically, the quantized code data is inverse-quantized by an inverse quantizing section 912 and then subjected to an inverse DCT by an inverse DCT section 913 to decode the differential image, and the prediction image is added to the differential image by an image adding section 914. As a result, a decoded image, which is used as the reference image, is generated. The reference image is stored in a reference image buffer region 915 of the memory 812 via the memory controller 810. The code data thus generated is stored in a code data buffer region 916 of the memory 812 via the memory controller 810.

As described so far, it is necessary in the conventional moving imaging coding device to store the image data in at least one frame in the memory 812 as the reference image for the inter-frame prediction coding. With expected increases of an image size to be handled in the future, number of memories needed to store the reference images, and an increasingly busier memory traffic caused by writing and reading data so often in the memories, particularly when handling HDTV-level moving images, are becoming serious issues in the development of mobile devices, for instance, digital camera, for which downsizing and low power consumption are demanded.

There were a few technical approaches for reducing the memory traffic and the storage capacity for the reference images.

The Cited Document 1 discloses a reference image compression method wherein Hadamard transformation is used. The technology recited in the Cited Document 2 is technically characterized in that it is unnecessary to store the reference images. According to the technology, image data already coded is decoded to obtain the reference image, and a region for storing any reference images necessary at the time is obtained whenever data is coded, so that the memory traffic and reference image storage can be reduced.

### PRIOR ART DOCUMENTS

Patent Document 1: Japanese Patent No. 3568392

Patent Document 2: Unexamined Japanese Patent Applications Laid-Open No. 2003-070000

### DISCLOSURE OF THE INVENTION

### Problem to be Solved by the Invention

The Hadamard transformation is lossy compression. Therefore, the invention recited the Cited Document 1 involves the risk of generating mismatch with decoder-side images when the Hadamard transformation is applied to the reference image, possibly undermining an image quality. The Cited Document 1 suggests a technical solution for alleviating the risk, which is to remove high frequency components by reducing a part of AC coefficients of code data. The solution, however, deteriorates an image resolution.

Such a mismatch does not occur in the invention recited in the Cited Document 2. To decode the reference image, however, it is necessary to decode all of frames used in coding including a first frame used for the inter-frame prediction coding, resulting in number of decoding processes equal to number of predictions when each frame is coded. Thus, an immense volume of data has to be decoded according to the technology. This raises another technical need of setting restrictions to reduce the number of predictions, leading to deterioration of a coding efficiency.

The present invention was carried out in view of these technical issues, and a main object thereof is to solve any problems associated with a large number of accesses to reference images in inter-frame prediction coding employed to code moving images.

### Means for Solving the Problems

The present invention provides a moving image coding device wherein inter-frame correlation in a moving image is utilized to compress the moving image. The moving image coding device comprises, an input image buffer for storing therein a plurality of continuous inputted frames, a multiple frame parallel processing inter-frame prediction coding unit for simultaneously performing inter-frame prediction coding to the plurality of input frames in the input image buffer in parallel, a code data buffer for storing therein code data of the coded plurality of frames, and a coding-linked perfect decoding reference image generating unit for reading the code data of all of frames required to decode a reference image from the code data buffer and simultaneously decoding all of the code data in parallel with the inter-frame prediction coding to generate the reference image of a region necessary for the inter-frame prediction coding whenever necessary.

The multiple frame parallel processing inter-frame prediction coding unit may comprise a plurality of picture coders for simultaneously performing the inter-frame prediction coding of the plurality of frames in parallel, and a coding reference image buffer for storing therein the reference image of the region outputted from the coding-linked perfect decoding reference image generating unit to be used by the picture coders.

The multiple frame parallel processing inter-frame prediction coding unit may comprise a plurality of picture coders for simultaneously performing the inter-frame prediction coding of the plurality of frames in parallel, a coding reference image buffer for storing therein the reference image of the region outputted from the coding-linked perfect decoding reference image generating unit to be used by the picture coders, a local decoder for generating the reference image by decoding outputs of the picture coders to use the input frame as the reference image, and a local decoding reference image buffer for storing therein the reference image generated by the local decoder.

The coding-linked perfect decoding reference image generating unit may comprise a plurality of picture decoders for reading the code data of the all of frames required to decode the reference image and simultaneously decoding the all of frames in parallel, and a plurality of decoding reference image buffers for storing therein the reference image to be used by the picture decoders.

The picture coders of the multiple frame parallel processing inter-frame prediction coding unit may each comprise at least one I/P picture coder for coding an intra-frame coded I (Intra) picture or a forward inter-frame prediction coded P (predictive) picture, and a plurality of B picture coders for coding a bidirectional inter-frame prediction coded B (bidirectional predictive) picture.

At least the multiple frame parallel processing inter-frame prediction coding unit and coding-linked perfect decoding reference image generating unit may be mounted in a single semiconductor chip (LSI).

An imaging apparatus according to the present invention comprises the moving image coding device described so far. Preferable examples of the imaging apparatus are; digital still camera, video movie camera, mobile telephone with camera, and monitoring camera.

A moving image coding method for compressing a moving image using inter-frame correlation in the moving image according to the present invention includes a reference image generating step for generating an image correlative to an input frame as a reference image; and an inter-frame prediction coding step for performing generally called inter-frame prediction coding using the input frame and the reference image and outputting code data. The reference image generating step includes a code data storing step for storing the code data outputted in the inter-frame prediction coding step, and a reference image decoding step for generating the reference image by decoding all of the code data necessary for decoding the reference image stored in the code data storing step. The inter-frame prediction coding step includes an input image storing step for storing a plurality of continuous input frames, and a plurality of inter-frame prediction coding steps for simultaneously performing the inter-frame prediction coding to the plurality of input frames stored in the input image storing step in parallel.

The present invention is technically characterized in that the coding-linked perfect decoding reference image generating unit which generates the needed reference image whenever necessary in synchronization with the coding process is provided. This makes it unnecessary to store the reference image in a memory as an image to be stored, significantly reducing a required capacity of the memory and its memory traffic. The present invention is further technically characterized in that the multiple frame parallel processing inter-frame prediction coding unit which can code the plurality of frames in parallel is provided. Therefore, the plurality of frames can be collectively coded at once, which makes it unnecessary to decode the reference image in the coding-linked perfect decoding reference image generating unit by each frame, thereby restraining a decoding volume from increasing as the number of predictions increases. Such a technical advantage only needs a realistic circuit size even allowing for as many predictions as demanded for the operation. Further, the coding-linked perfect decoding reference image generating unit reads the code data just once for the plurality of frames, further reducing the memory traffic. These technical advantages can further reduce power consumption in the moving image coding device provided in a digital still camera and mobile telephone with camera for which downsizing and low power consumption are the long-desired targets to be accomplished, and improve the performance of these devices in, for example, handing DTV-level moving images while preventing power increase.

### EFFECT OF THE INVENTION

According to the present invention, wherein the coding-linked perfect decoding reference image generating unit generates the reference image from the code data read from the code data buffer, it is unnecessary to store the reference image in a memory as an image to be stored, and a memory used for the reference image and its memory traffic can be largely reduced. Further, according to the multiple frame parallel processing inter-frame prediction coding unit which can simultaneously code the plurality of input frames, the coding-linked perfect decoding reference image generating unit can collectively decode the frames at once in place of decoding them by each frame, thereby decreasing a processing volume by each frame. Such a technical advantage only needs a realistic circuit size even allowing for as many predictions as demanded for the operation.

### BRIEF DESCRIPTION OF THE DRAWINGS

FIG. 1 is a block diagram illustrating a structure of an imaging apparatus according to a preferred embodiment of the present invention.

FIG. 2 is a block diagram illustrating a structure of a moving image coding device provided in the imaging device of FIG. 1.

FIG. 3 is a block diagram illustrating structures of an I/P picture coder and a local decoder according to the preferred embodiment.

FIG. 4 is a block diagram illustrating a structure of a P picture decoder according to the preferred embodiment.

FIG. 5A is an illustration of a GOP handled by the moving image coding device according to the preferred embodiment in a chronological order.

FIG. 5B is an illustration of a GOP handled by the moving image coding device according to the preferred embodiment in a coding order.

FIG. 6 is an illustration of processing details in the GOPs illustrated in FIGS. 5A and 5B according to the preferred embodiment.

FIG. 7 is an illustration of more specific processing details according to the preferred embodiment.

FIG. 8 is an illustration of storage contents of a reference image buffer according to the preferred embodiment.

FIG. 9 is a block diagram illustrating a structure of a digital still camera equipped with the moving image coding device.

FIG. 10 is a block diagram illustrating a structure of a conventional moving image coding device.

### PREFERRED EMBODIMENT OF THE PRESENT INVENTION

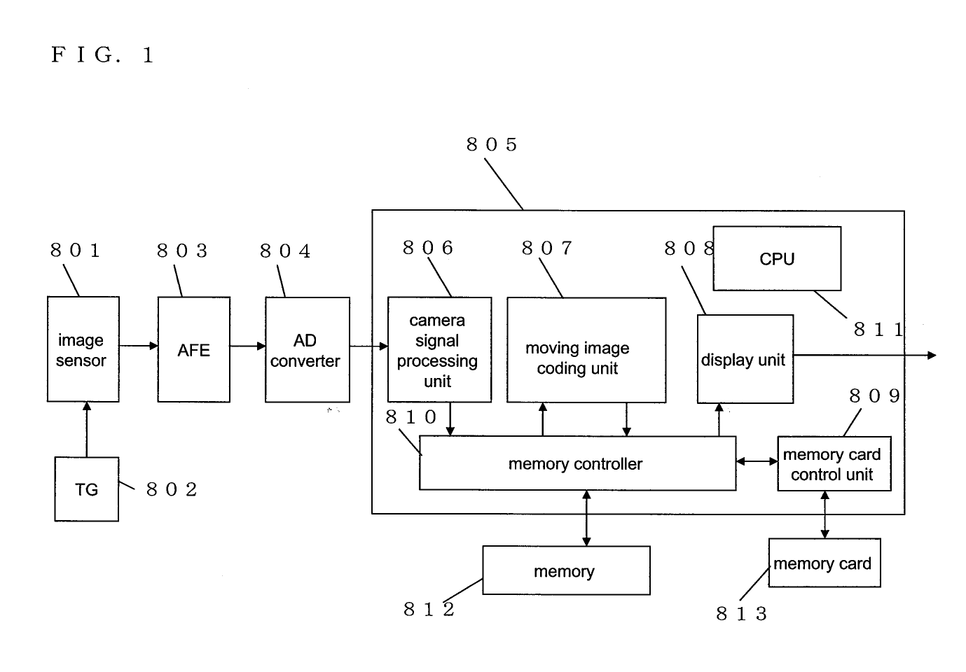

A preferred embodiment of the present invention is described referring to FIGS. 1-8.

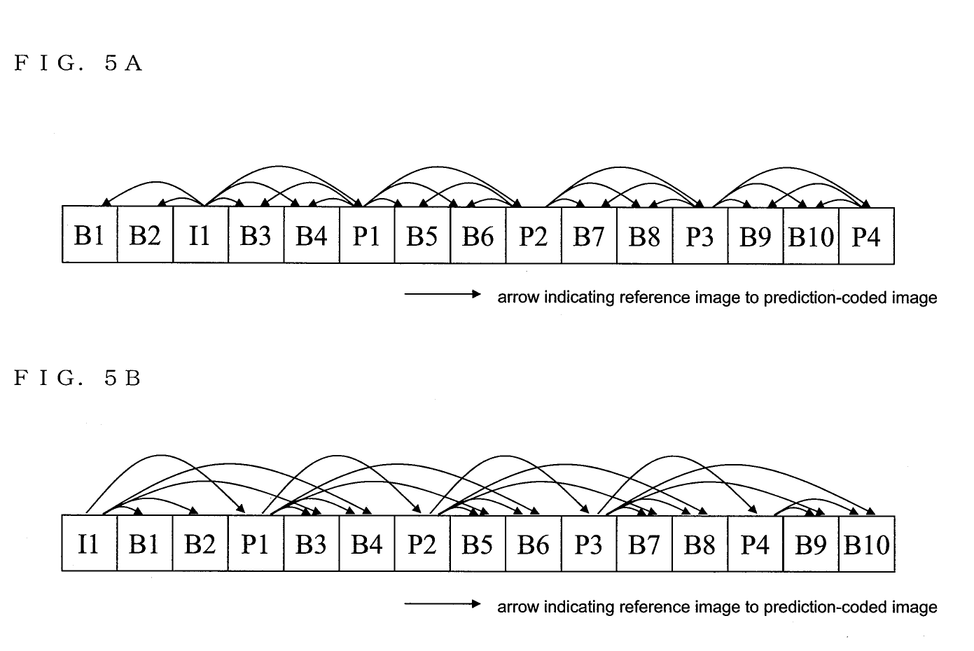

FIGS. 5A and 5B illustrate a referential relationship between frames in inter-frame prediction coding. In these drawings are illustrated a unit called GOP (group of pictures) including a plurality of frames for the inter-frame prediction coding, which uses a general format viewable on DVD which employs the moving image coding standard, MPEG02, standardized by the MPEG (Moving Picture Coding Experts Group) is used. I represents intra picture, which is responsible for intra-frame coding alone. The intra picture does not reference any of the frames but is used as the basis of all of the frames in the GOP. P denotes predictive picture, which performs coding based on prediction using the past frames as the reference image. B represents bidirectionally predictive picture which uses the past and future frames as the reference image. The B picture which references the future frames, wherein a coding order is different to an actual chronological order of the frames. FIG. 5A illustrates the chronological order, while FIG. 5B illustrates the coding order.

First, I1 is coded. When I1 is coded, no reference image is necessary as described earlier. Then, B1 and B2 chronologically later than I1 are subjected to prediction coding in which I1 is used as its reference image. To simplify the description, the GOP in this example is characterized in that coding is completed in one GOP called Closed GOP to which any of other GOPs is irrelevant. Therefore, B1 and B2 are prediction-coded based on I1 of the GOP alone. Next, P1 is prediction-coded based on I1, and B3 and B4, which are the bidirectionally predictive pictures, are prediction-coded using I1 and P1 as their reference images. Then, P2 is subjected to prediction coding in which P1 is used as its reference image, and B5 and B6 are subjected prediction coding in which P1 and P2 are used as their reference images, further followed by prediction coding of P3 based on P2, B7 and B8 based on P2 and P3, P4 based on P3, and then B9 and B10 based on P3 and P4.

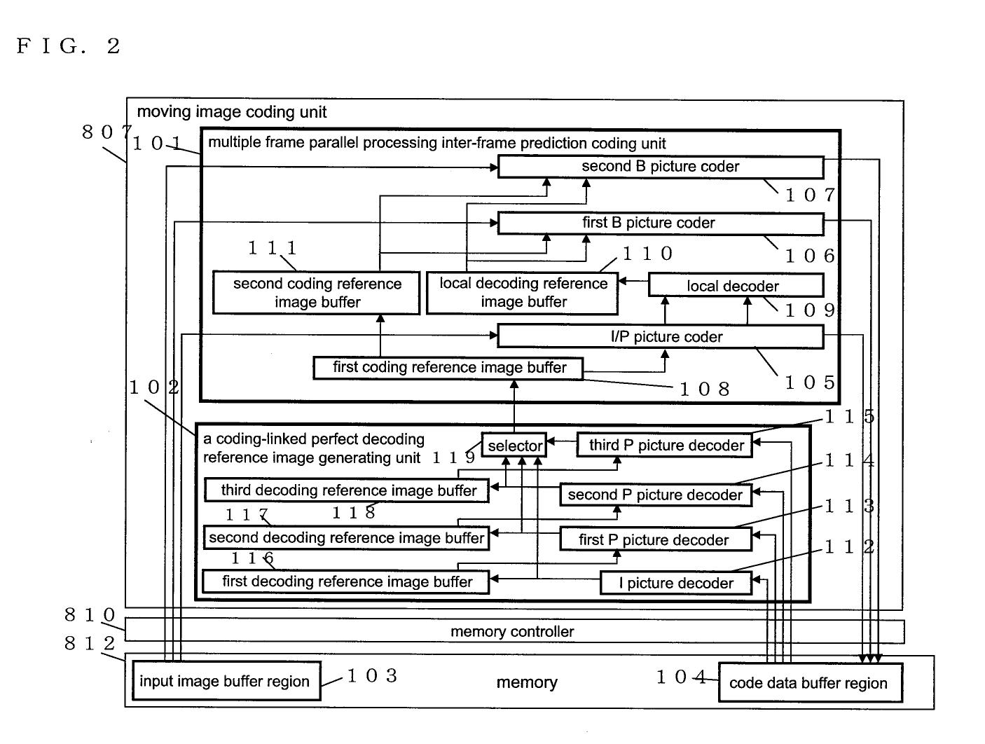

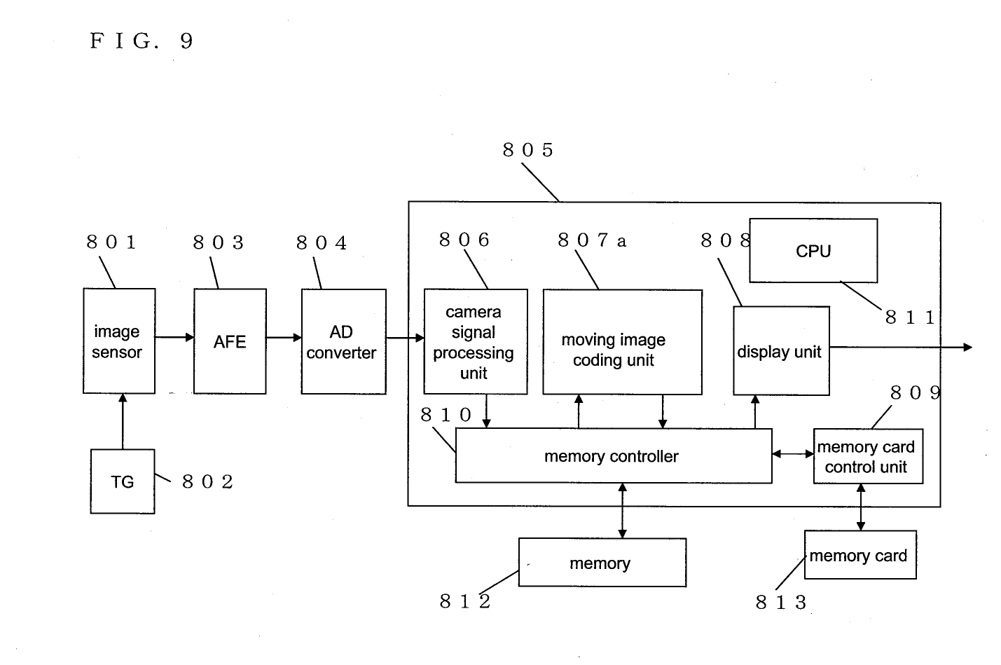

Referring to FIGS. 1 and 2, the present preferred embodiment is described. FIG. 1 is a block diagram illustrating a structure of an imaging apparatus according to the present preferred embodiment, an example of which is a digital still camera. Any structural components of the imaging apparatus corresponding to those illustrated in FIG. 9 are simply shown with the same reference symbols with no description.

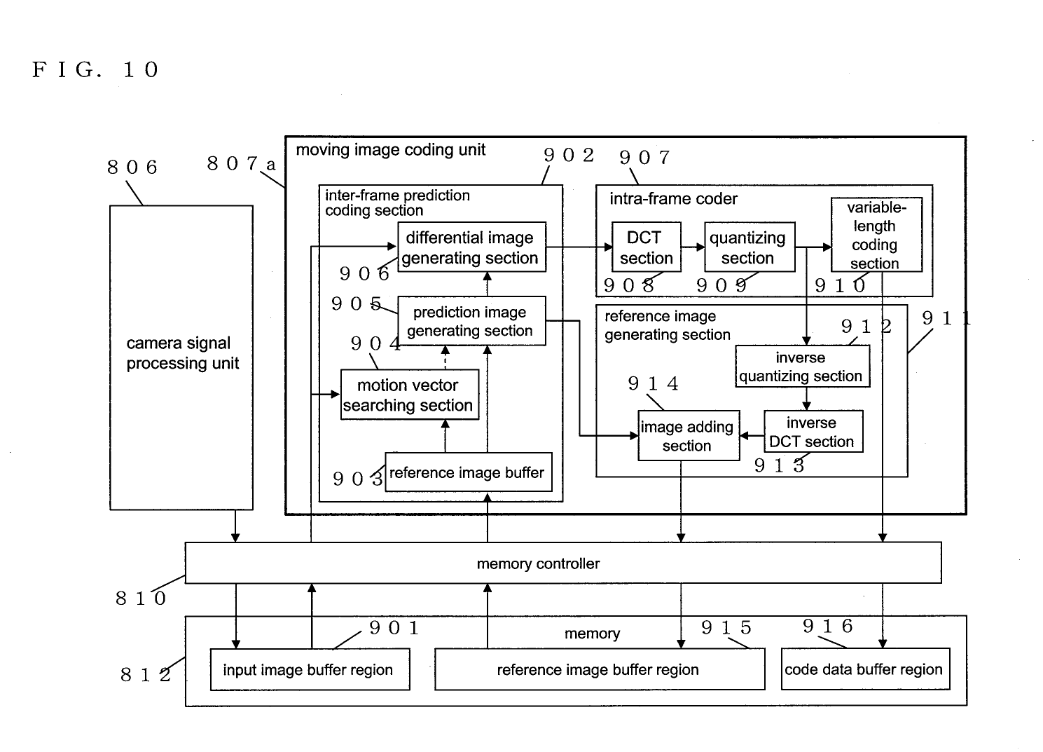

FIG. 2 is a block diagram illustrating a structure of the moving image coding device according to the present preferred embodiment which constitutes a moving image coding device 807 provided in the imaging apparatus illustrated in FIG. 1. Any structural components corresponding to those illustrated in FIG. 10 are shown with the same reference symbols.

There are two principal structural elements in the moving image coding device according to the present preferred embodiment. One of them is a multiple frame parallel processing inter-frame prediction coding unit 101, and the other is a coding-linked perfect decoding reference image generating unit 102. The moving image coding device 807 including the multiple frame parallel processing inter-frame prediction coding unit 101 and the coding-linked perfect decoding reference image generating unit 102 are mounted in a single semiconductor chip (LSI).

The multiple frame parallel processing inter-frame prediction coding unit 101 codes a plurality of frames in parallel and outputs code data of the plurality of frames over a plurality of frame periods. An input image buffer region 103 is provided in a memory 812 to input the plurality of frames to the multiple frame parallel processing inter-frame prediction coding unit 101 in parallel. The plurality of input frames which are continuous are temporarily stored in the input image buffer region 103, and the plurality of frames are then outputted in parallel to the multiple frame parallel processing inter-frame prediction coding unit 101. Conventionally, the memory 812 and memory controller 810 are mounted in another chip (LSI) separately provided, and it is physically difficult to provide a plurality of connections between the two chips. To implement the parallel operation, therefore, an image frame is divided into small data units, and data of the different frames are sequentially transmitted.

The coding-linked perfect decoding reference image generating unit 102 generates the reference image needed for coding whenever necessary in synchronization with the coding. Therefore, the reference image buffer 915 illustrated in FIG. 10 which stores therein the reference images for one frame can be omitted. Because the reference image is generated whenever necessary in synchronization with the coding, all of the frames used to code the target reference image are decoded from the code data so that the reference image is generated. Therefore, the code data of all of the necessary frames are stored in a code data buffer region 104 of the memory 812. Thus, the reference image can be generated by simply reading the code data, in which it is unnecessary read an image as in the conventional moving image coding device. This technical characteristic can significantly lessen the memory traffic.

Next, an internal structure of the multiple frame parallel processing inter-frame prediction coding unit 101 is described. According to the present preferred embodiment wherein the GOP structures illustrated in FIGS. 5A and 5B are optimized, one I picture and two B pictures continuous thereto, or one P picture and two B pictures continuous thereto are processed in parallel. More specifically, I1, B1 and B2 of FIGS. 5A and 5B are processed in parallel, and P1, B3 and B4 are then processed in parallel. Then, one P and two Bs are similarly processed in parallel. To accomplish such a parallel processing, the multiple frame parallel processing inter-frame prediction coding unit 101 is provided with an I/P picture coder 105 for coding one I picture or P picture, and two B picture coders, which are a first 1B picture coder 106 and a second B picture coder 107, and is further provided with a first coding reference image buffer 108 for obtaining the reference image necessary for coding the P picture from coding-linked perfect decoding reference image generating unit 102 and storing therein the obtained reference image. Further provided are a local decoder 109 for obtaining data currently coded before being subjected to lossy compression from the I/P picture coder 105 and locally decoding the obtained data so that the B picture uses the P picture coded by the I/P picture coder 105 as the reference image for backward prediction, and a local decoding reference image buffer 110 for storing therein the image decoded by the local decoder 109 to be used later as the reference image. The B picture uses the reference image obtained from the coding-linked perfect decoding reference image generating unit 102 for forward prediction in a manner similar to the P picture. However, the B picture is inevitably coded later than the P picture, and a second coding reference image buffer 111, therefore, is further provided to store therein the reference image until then.

Next, an internal structure of the coding-linked perfect decoding reference image generating unit 102 is described based on the GOP structures illustrated in FIGS. 5A and 5B. Though described later in more detail, P4, B9 and B10 are coded in parallel in a final stage in the GOP structures illustrated in FIGS. 5A and 5B. To code these pictures, it is necessary to generate P3 as the reference image, which means I1, P1, P2 and P3 have to be decoded. To decode these pictures, the coding-linked perfect decoding reference image generating unit 102 is provided with an I picture decoder 112, and three P picture decoders, which are a first P picture decoder 113, a second P picture decoder 114, and a third P picture decoder 115, and is further provided with three decoding reference image buffers for storing therein the reference images needed to decode these three P pictures, which are a first decoding reference image buffer 116, a second decoding reference image buffer 117, and a third decoding reference image buffer 118. A selector 119 is provided to select the reference image needed by the multiple frame parallel processing inter-frame prediction coding unit 101. According to the GOP structures illustrated in FIGS. 5A and 5B, for example, I1 alone is initially decoded. Therefore, the I picture decoder 112 alone is activated first to output the reference image thereby obtained to the multiple frame parallel processing inter-frame prediction coding unit 101.

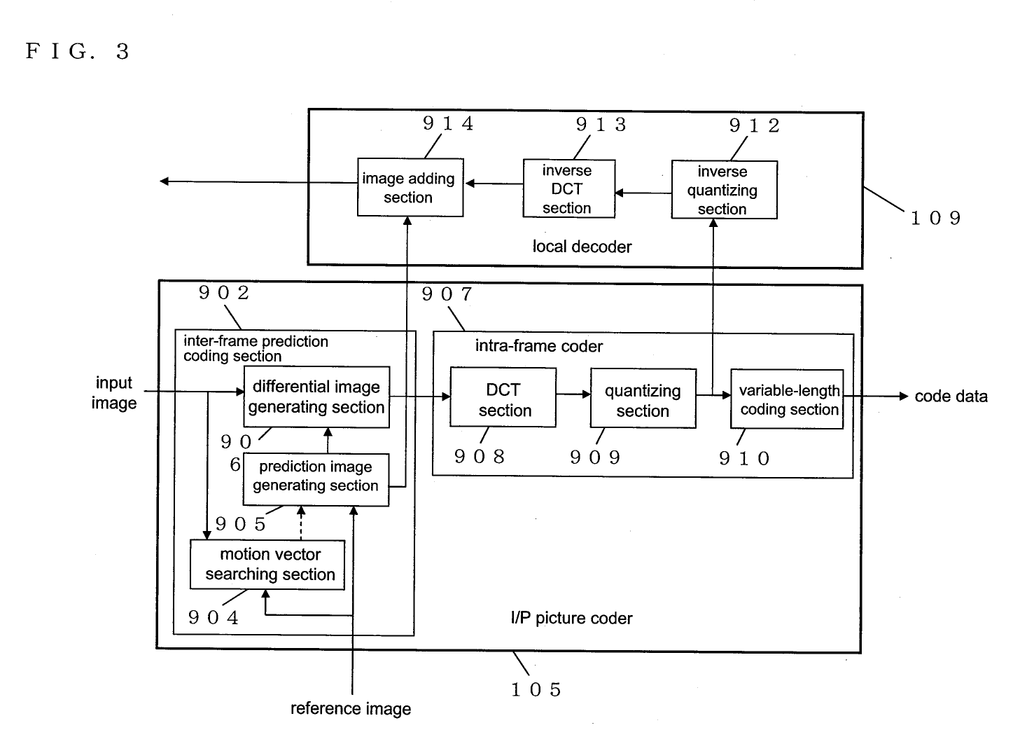

In this section, internal structures of structural elements provided in these units are described. First, internal structures of structural elements provided in the multiple frame parallel processing inter-frame prediction coding unit 101 are described. FIG. 3 is a block diagram illustrating structures of the I/P picture coder 105 and the local decoder 109. The structures of these devices are basically similar to those illustrated in FIG. 10, and the structural elements are shown with the same reference symbols as those of the conventional example and will not be described in detail. Likewise, the B picture coders 106 and 107 are basically similar to the conventional example, I/O picture coder 105. The only difference is two frames for forward prediction and backward prediction are inputted as the reference image.

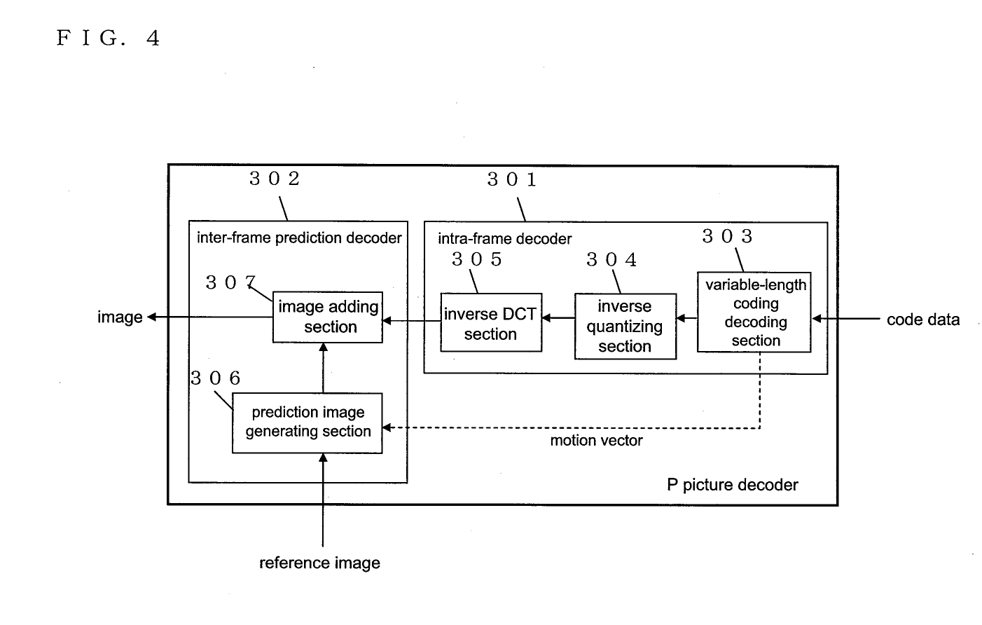

Next, internal structures of structural elements provided in the multiple frame coding-linked perfect decoding reference image generating unit 102 are described. FIG. 4 is a block diagram illustrating the structures of the P picture decoders 113-115. There are two main devices provided therein, which are an intra-frame decoder 301 and an inter-frame prediction decoder 302. The intra-frame decoder 301 has a variable-length coding decoding section 303, an inverse quantizing section 304, and an inverse DCT section 305. The intra-frame decoding section 301 carries out intra-frame decoding using these devices. As a result, an inter-frame prediction coded image is obtained.

The inter-frame prediction decoder 302 decodes the inter-frame prediction coded image. The inter-frame prediction decoder 302 has a prediction image generating section 306 for generating an image predicted from the reference image, and an image adding section 307 for adding the prediction image to the inter-frame prediction coded image to obtain the P picture. A motion vector is transmitted from the variable-length coding decoding section 303 to the prediction image generating section 306 to generate the prediction image from the reference image. The only structural element of the I picture decoder is an intra-frame decoding section, wherein decoding of the I picture can be finalized by the intra-frame decoding section alone.

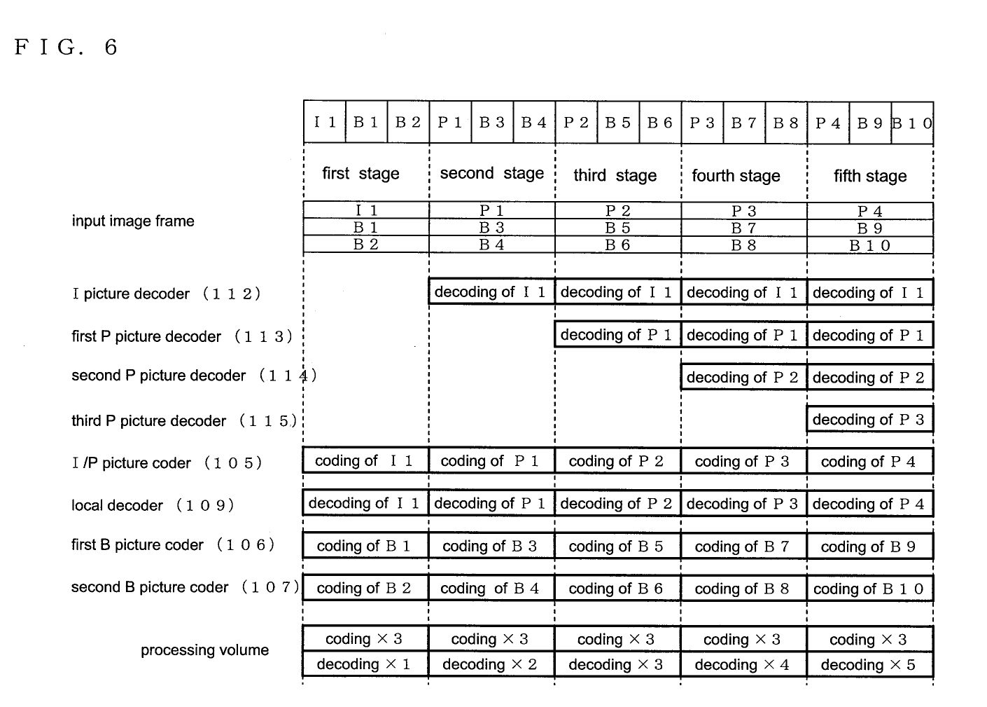

Next, the operation of the moving image coding device according to the present preferred embodiment is described. FIG. 6 is a drawing of a processing sequence carried out by the structural elements illustrated in FIG. 2 when the GOPs of FIGS. 5A and 5B are coded. More specifically, the drawing illustrates input image frames, I picture decoder 112, first P picture decoder 113, second P picture decoder 114, third P picture decoder 115, I/P picture coder 105, local decoder 109, first B picture coder 106, second B picture coder 107, and respective processing volumes.

To code three frames in parallel, the processing sequence according to the present preferred embodiment has five stages each including processing of three frames.

In the first stage, I1, B1 and B2 are coded in parallel. First, the I/P picture coder 105 codes I1. After I1 is coded by a predetermined volume, the reference images necessary for coding B1 and B2 are decoded by the local decoder 109 and stored in the local decoding reference image buffer 110. Then, the reference images stored in the local decoding reference image buffer 110 are used to code B1 in the first B picture coder 106 and code B2 in the second B picture coder 107.

In the second stage P1, B3 and B4 are coded in parallel. First, the I picture decoder 112 decodes I1, and the reference image necessary for coding P1 is generated. The reference image thus generated and used to code P1 is transmitted to the multiple frame parallel processing inter-frame prediction coding unit 101 via the selector 119, and stored in the first coding reference image buffer 108. Then, the I/P picture coder 105 codes P1. After P1 is coded by a predetermined volume in a manner similar to I1, the reference images necessary for coding B3 and B4 are decoded by the local decoder 109 and stored in the local decoding reference image buffer 110. The reference image stored in the first coding reference image buffer 108 is transmitted to the second coding reference image buffer 111. The B picture is coded subsequent to coding of P1. Therefore, the reference image, though needed for forward coding of the B picture, is temporarily thus stored in these buffers until coding of the B picture starts. Then, the first picture coder 106 codes B3, and the second picture coder 107 codes B4 using the reference images respectively stored in the local decoding reference image buffer 110 and the second coding reference image buffer 111.

In the third stage, P2, B5 and B6 are coded in parallel. First, the I picture decoder 112 decodes I1 again, and the reference image necessary for decoding P1 is generated and stored in the first decoding reference image buffer 116. Then, the first P picture decoder 113 decodes P1 using the reference image stored in the first decoding reference image buffer 116 to generate the reference image for coding. The reference image necessary for coding thus generated is transmitted to the multiple frame parallel processing inter-frame prediction coding unit 101 via the selector 119 and stored in the first coding reference image buffer 108. Then, the I/P picture coder 105 codes P2. After P2 is coded by a predetermined volume in a manner similar to the coding of P1, the reference images necessary for coding B5 and B6 are decoded by the local decoder 109 and stored in the local decoding reference image buffer 110. The reference image stored in the first coding reference image buffer 108 is transmitted to the second coding reference image buffer 111. Then, the first B picture coder 106 codes B5, and the second B picture coder 107 codes B6 using the reference images respectively stored in the local decoding reference image buffer 110 and the second coding reference image buffer 111 in a manner similar to the coding of B3 and B4.

In the fourth stage, P3, B7 and B8 are coded in parallel. First, the I picture decoder 112 decodes I1 again, and the reference image necessary for decoding P1 is generated and stored in the first decoding reference image buffer 116. Then, the first P picture decoder 113 decodes P1 using the reference image stored in the first decoding reference image buffer 116 to generate the reference image necessary for decoding P2. The generated reference image is stored in the second coding reference image buffer 117. The second P picture decoder 114 decodes P2 using the reference image stored in the second decoding reference image buffer 117 to generate the reference image necessary for coding. The reference image necessary for coding thus generated is transmitted to the multiple frame parallel processing inter-frame prediction coding unit 101 via the selector 119 and stored in the first coding reference image buffer 108. Then, the I/P picture coder 105 codes P3. After P3 is coded by a predetermined volume in a manner similar to the coding of P2, the reference images necessary for coding B7 and B8 are decoded by the local decoder 109 and stored in the local decoding reference image buffer 110. The reference images stored in the first coding reference image buffer 108 are transmitted to the second coding reference image buffer 111. Then, the first B picture coder 106 codes B7, and the second B picture coder 107 codes B8 using the reference images respectively stored in the local decoding reference image buffer 110 and the second coding reference image buffer 111 in a manner similar to the coding of B5 and B6.

In the fifth stage, P4, B9 and B10 are coded in parallel. First, the I picture decoder 112 decodes I1 again, and the reference image necessary for decoding P1 is generated and stored in the first decoding reference image buffer 116. Then, the first P picture decoder 113 decodes P1 using the reference image stored in the first decoding reference image buffer 116 to generate the reference image necessary for decoding P2. The generated reference image is stored in the second coding reference image buffer 117. After that, the second P picture decoder 114 decodes P2 using the reference image stored in the second decoding reference image buffer 117 to generate the reference image necessary to decode P3. The reference image thus generated is stored in the third decoding reference image buffer 118. The third P picture decoder 115 decodes P3 using the reference image stored in the third decoding reference image buffer 118 to generate the reference image necessary for coding. The reference image necessary for coding thus generated is transmitted to the multiple frame parallel processing inter-frame prediction coding unit 101 via the selector 119 and stored in the first coding reference image buffer 108. Then, the I/P picture coder 105 codes P4. After P4 is coded by a predetermined volume in a manner similar to the coding of P3, the reference images necessary for coding B9 and B10 are decoded by the local decoder 109 and stored in the local decoding reference image buffer 110. The reference image stored in the first coding reference image buffer 108 is transmitted to the second coding reference image buffer 111. Then, the first B picture coder 106 codes B9, and the second B picture coder 107 codes B10 using the reference images respectively stored in the local decoding reference image buffer 110 and the second coding reference image buffer 111 in a manner similar to the coding of B7 and B8.

The bottom section in the drawing shows processing volumes in the respective stages. In the fifth stage where the processing volume shows a largest volume, three frames are coded and five frames are decoded in three frame periods. Compared to the conventional processing, in which one frame is coded and decoded in one frame period, a coding volume is equal to that of the conventional processing, and a decoding volume is 5/3 times, thus achieving a processing volume 4/3 times as large on the whole. However, these are feasible coding and decoding volumes.

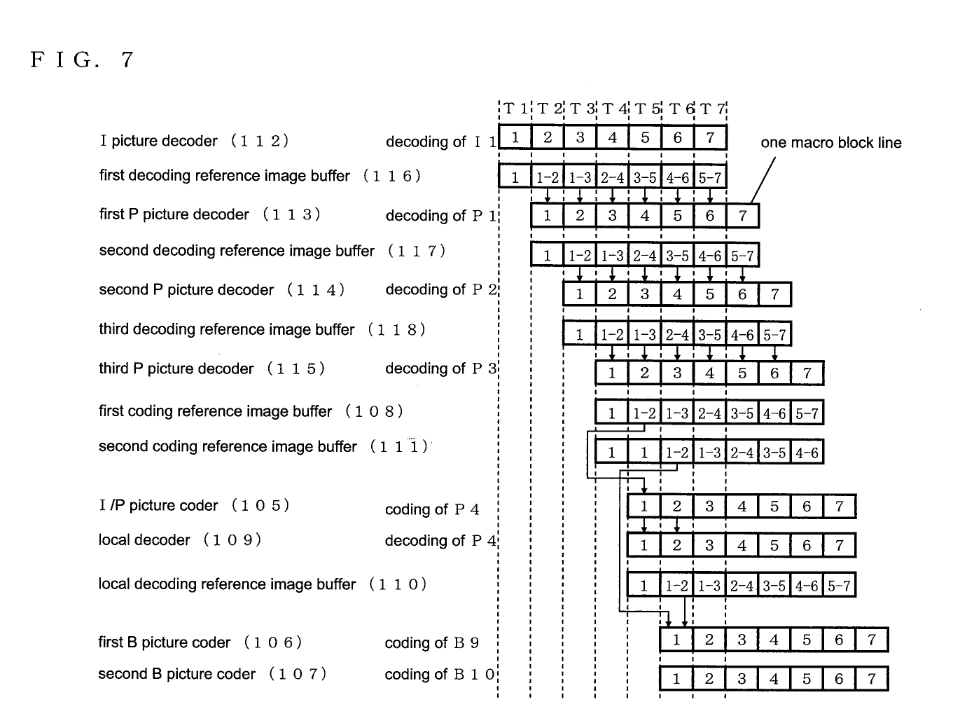

These stages are described below based on a more detailed chronological scale. The fifth stage having the largest processing volume is described for instance. FIG. 7 is a drawing of a processing sequence in which the operation in the fifth stage is illustrated per macro block line. More specifically, the processing sequence illustrates decoding of I1 by the I picture decoder 112, first decoding reference image buffer 116, decoding of P1 by the first P picture decoder 113, second decoding reference image buffer 117, decoding of P2 by the second P picture decoder 114, third decoding reference image buffer 118, decoding of P3 by the third P picture decoder 115, first coding reference image buffer 108, second coding reference image buffer 111, coding of P4 by the I/P picture coder 105, decoding of P4 by the local decoder 109, local coding reference image buffer 110, coding of B9 by the first B picture coder 106, and coding of B10 by the second B picture coder 107.

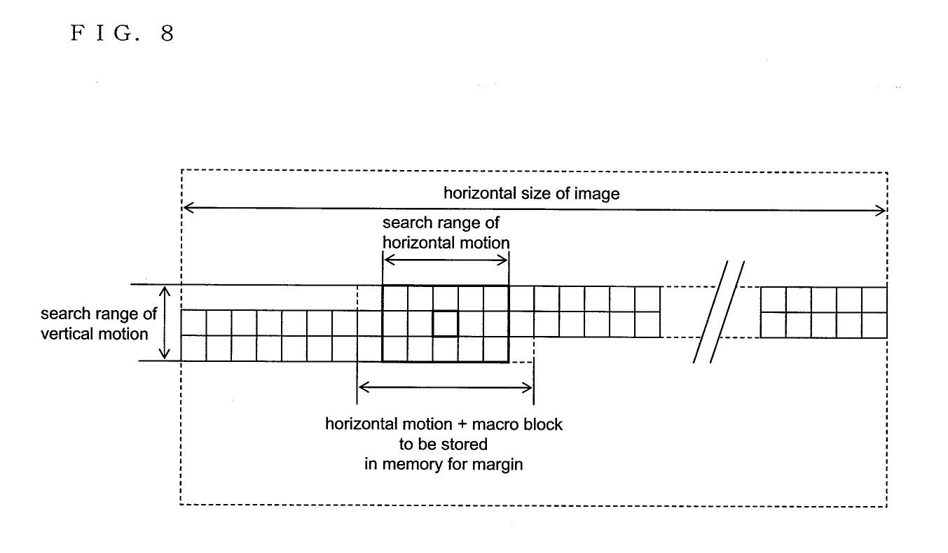

In the macro block line, macro blocks, each of which is used as a basic coding unit, are aligned in a frame to be coded in a horizontal direction. It is necessary to prepare macro block lines equivalent to the range of motion compensation in a vertical direction for motion-compensated prediction coding. FIG. 8 illustrates an example of the macro blocks. In the example of FIG. 8, ±32 pixels horizontally (two macro blocks) and ±16 pixels vertically (one macro block) are set as a motion vector search range for motion compensation. Therefore, there are horizontally five macro blocks and vertically three macro blocks in the motion vector search range, and it is necessary to store the reference images included in the range during the motion vector search. As is known from FIG. 8, it is necessary to store the reference images for at least two macro block lines+horizontal search range in the reference image buffer.

The illustration of FIG. 7 is described below based on the requirement given earlier. T1-T7 each denotes a time period when the macro block line is processed. First, the I picture decoder 112 decodes I1 to generate the reference image necessary for decoding P1. To decode the first macro block line in P1, images of the first macro block line and the second block line in I1 are needed as the reference image. In the period T1, the first macro block line of I1 is decoded. After the second macro block line equivalent to horizontal motion compensation is decoded, the first P picture decoder 113 starts to decode the first macro block line of P1. In FIG. 7 illustrating time by each macro block line, the second macro block line of I1 and the first macro block line of P1 are both decoded in the period T2. The first decoding reference image buffer 116 stores therein a region necessary for motion compensation in the first and second macro block lines of I1. To decode the second macro block line in P1, images from the first to third macro block lines of I1 are needed as the reference image. The third macro block line equivalent to horizontal motion compensation is decoded in the period T3 subsequent to the decoding of the second macro block line of I1 in the period T2. Then, decoding of the second macro block line in P1 starts, and the third macro block line of I1 and the second macro block line of P1 are both decoded in the period T3. The first decoding reference image buffer 116 stores therein a region necessary for motion compensation in the first to third macro block lines of I1. Then, the third macro block line and the macro block lines thereafter in P1 are similarly decoded.

The second P picture decoder 114 decodes P2. In a manner similar to the decoding of P1, images of the first and second macro block lines of P1 are necessary for decoding the first macro block line of P2. After the first macro block line of P1 is decoded in the period T2, and the second block line equivalent to horizontal motion compensation is then decoded in the period T3, the second P picture decoder 114 starts to decode the first macro block line of P2. Then, the second macro block line of P1 and the first macro block line of P2 are both decoded in the period T3. The second decoding reference image buffer 117 stores therein a region necessary for motion compensation in the first and second macro block lines of P1. To decode the second macro block line of P2, images of the first to third macro block lines of P1 are needed. After the third macro block line equivalent to horizontal motion compensation is decoded in the period T4, decoding of the second macro block line in P2 starts. Then, the third macro block line of P1 and the second macro block line of P2 are both decoded in the period T4. The second decoding reference image buffer 117 stores therein a region necessary for motion compensation in the first to third macro block lines of P1. Then, the third macro block line and the macro block lines thereafter in P2 are similarly decoded.

The third P picture decoder 115 decodes P3. In a manner similar to the decoding of P2, images of the first and second macro block lines of P2 are necessary for decoding first macro block line of P3. After the first macro block line of P2 is decoded in the period T3, and the second block line equivalent to horizontal motion compensation is then decoded in the period T4, the third P picture decoder 115 starts to decode the first macro block line of P3. Then, the second macro block line of P2 and the first macro block line of P3 are both decoded in the period T4. The third decoding reference image buffer 118 stores therein a region necessary for motion compensation in the first and second macro block lines of P2. To decode the second macro block line of P3, images of the first to third macro block lines of P2 are necessary. After the third macro block line equivalent to horizontal motion compensation is decoded in the period T5, decoding of the second macro block line in P3 starts. Then, the third macro block line of P2 and the second macro block line of P3 are both decoded in the period T5. The third decoding reference image buffer 118 stores therein a region necessary for motion compensation in the first to third macro block lines of P2. Then, the third macro block line and the macro block lines thereafter in P3 are similarly decoded. The image of P3 decoded by the third P picture decoder 115 is stored in the first coding reference image buffer 108.

Then, the I/P picture coder 105 codes P4. After the first macro block line of P3 is decoded in the period T4, the second macro block line equivalent to horizontal motion compensation is decoded and stored in the first coding reference image buffer 108. Then, the I/P picture coder 105 starts to code the first macro block line of P4, and the first macro block line of P4 is coded in the period T5. Then, the third macro block line equivalent to horizontal motion compensation is decoded in the period T6, and the second macro block line of P4 is then coded. The third macro block line of P3 and the second macro block line of P4 are both decoded in the period T6.

The local decoder 109 decodes P4 to generate the reference images used for backward prediction coding of B9 and B10. The first macro block line of P4 is decoded in the same period T5 so that the first macro block line of the reference images for backward prediction coding of B9 and B10 are generated. Similarly, the second macro block of P4 is decoded in the period T6, and the reference images thereby obtained are stored in the local decoding reference image buffer 110.

B9 and B10 are respectively coded by the first B picture coder 106 and the second B picture coder 107. To code the first macro block lines in B9 and B10, images of the first and second macro block lines of P3 are necessary as the reference image for forward prediction, and the first and second macro block lines of P4 are necessary as the reference image for backward prediction. As described earlier, after the first macro block line of P4 is decoded in the period T5, the second macro block line of P4 equivalent to horizontal motion compensation is decoded in the period T6, and the reference images thereby obtained are stored in the local decoding reference image buffer 110. Then, backward prediction coding of the first macro block lines in B9 and B10 starts. To carry out the backward prediction coding in the same period T6, the image of P3 stored in the first coding reference image buffer 108 as the reference image for forward prediction coding is transferred to the second coding reference image buffer 111. The second coding reference image buffer 111 stores therein the contents stored in the first coding reference image buffer 108 earlier by 1 T. More specifically, in the period T6, the second coding reference image buffer 111 stores therein the images of the first and second macro block lines in P3 as the reference image for forward prediction, and the local decoding reference image buffer 110 stores therein the images of the first and second macro block lines in P4 as the reference image for backward prediction. Then, in the period T6, the first B picture coder 106 and the second B picture coder 107 respectively code B9 and B10 using the both reference images thus stored. Then, the second macro block lines of B9 and B10 are similarly coded. To code the second macro block lines, images of the first to third macro block lines in P3 are necessary as the reference image for forward prediction, and images of the first to third macro block lines in P4 are necessary as the reference image for backward prediction. In the period T7, images of the first to third macro block lines in P3 are stored in the second coding reference image buffer 111, and images of the first to third macro block lines in P4 are stored in the local decoding reference image buffer 110. Then, the second macro block lines of B9 and B10 are respectively coded by the first B picture coder 106 and the second B picture coder 107. Thereafter, the third macro block and the macro block lines thereafter in B9 and B10 are similarly coded.

As described so far, the present preferred embodiment characteristically carries out the coding and decoding processes in turn constantly retaining the time difference equivalent to one macro block line therebetween. As the range of vertical motion compensation is broadened, there are more reference images to be stored in the buffers, which increases the time difference between the coding and decoding processes.

In the present preferred embodiment, three frames are coded in parallel, and only one P picture is coded. However, the embodiment can be variously modified or extended to a larger extent as far as it can stay within the scope of the technical idea and feature of the present invention, for example, to increase the number of frames to be coded in parallel or code a plurality of P pictures.

### INDUSTRIAL APPLICABILITY

The present invention can provided an advantageous moving image coding device for such imaging apparatuses as digital still camera, video movie camera, mobile telephone with camera, and monitoring camera.

### DESCRIPTION OF REFERENCE SYMBOLS

101 multiple frame parallel processing inter-frame prediction coding unit
102 coding-linked perfect decoding reference image generating unit
103 input image buffer region
104 code data buffer region
105 I/P picture coder
106 first B picture coder
107 second B picture coder
108 first coding reference image buffer
109 local decoder
110 local decoding reference image buffer
111 second coding reference image buffer
112 I picture decoder
113 first P picture decoder
114 second P picture decoder
115 third P picture decoder
116 first decoding reference image buffer
117 second decoding reference image buffer
118 third decoding reference image buffer
119 selector

What is claimed is:

1. A moving image coding device for compressing a moving image using inter-frame correlation in the moving image, comprising:
an input image buffer for storing therein a plurality of continuous inputted frames;
a multiple frame parallel processing inter-frame prediction coding unit for simultaneously performing inter-frame prediction coding to the plurality of input frames in the input image buffer in parallel;
a code data buffer for storing therein code data of the coded plurality of frames; and
a coding-linked perfect decoding reference image generating unit for reading the code data of all of frames required to decode a reference image from the code data buffer and simultaneously decoding all of the code data in parallel with the inter-frame prediction coding to generate the reference image of a region necessary for the inter-frame prediction coding whenever necessary.

2. The moving image coding device as claimed in claim 1, wherein
the multiple frame parallel processing inter-frame prediction coding unit comprises:
a plurality of picture coders for simultaneously performing the inter-frame prediction coding of the plurality of frames in parallel; and
a coding reference image buffer for storing therein the reference image of the region outputted from the coding-linked perfect decoding reference image generating unit to be used by the picture coders

3. The moving image coding device as claimed in claim 1, wherein
the multiple frame parallel processing inter-frame prediction coding unit comprises:
a plurality of picture coders for simultaneously performing the inter-frame prediction coding of the plurality of frames in parallel;
a coding reference image buffer for storing therein the reference image of the region outputted from the coding-linked perfect decoding reference image generating unit to be used by the picture coders;
a local decoder for generating the reference image by decoding outputs of the picture coders to use the input frame as the reference image; and
a local decoding reference image buffer for storing therein the reference image generated by the local decoder.

4. The moving image coding device as claimed in claim 1, wherein
the coding-linked perfect decoding reference image generating unit comprises:
a plurality of picture decoders for reading the code data of the all of frames required to decode the reference image and simultaneously decoding the all of frames in parallel; and
a plurality of decoding reference image buffers for storing therein the reference image to be used by the picture decoders.

5. The moving image coding device as claimed in claim 2 or 3, wherein
the picture coders of the multiple frame parallel processing inter-frame prediction coding unit each comprises:
at least one I/P picture coder for coding an intra-frame coded I (Intra) picture or a forward inter-frame prediction coded P (predictive) picture; and
a plurality of B picture coders for coding a bidirectional inter-frame prediction coded B (bidirectional predictive) picture.

6. The moving image coding device as claimed in claim 1, wherein
at least the multiple frame parallel processing inter-frame prediction coding unit and coding-linked perfect decoding reference image generating unit are mounted in a single semiconductor chip (LSI).

7. An imaging apparatus comprising the moving image coding device claimed in any of claims 1, 2, 3, 4 and 6.

8. The imaging apparatus as claimed in claim 7, wherein the imaging apparatus is any of a digital still camera, a video movie camera, a mobile telephone with camera, and a monitoring camera.

9. A moving image coding method for compressing a moving image using inter-frame correlation in the moving image, including:
a reference image generating step for generating an image correlative to an input frame as a reference image to utilize time correlation of moving images for compression; and
an inter-frame prediction coding step for performing generally called inter-frame prediction coding using the input frame and the reference image and outputting code data, wherein
the reference image generating step includes a code data storing step for storing the code data outputted in the inter-frame prediction coding step, and a reference image decoding step for generating the reference image by decoding all of the code data necessary for decoding the reference image stored in the code data storing step, and
the inter-frame prediction coding step includes an input image storing step for storing a plurality of continuous input frames, and a plurality of inter-frame prediction coding steps for simultaneously performing the inter-frame prediction coding to the plurality of input frames stored in the input image storing step in parallel.
